(19) United States
(12) Patent Application Publication
(10) Pub. No.: US 2026/0291233 A1
(43) Pub. Date: Sep. 24, 2026

(54) SYSTEM AND METHOD FOR INTELLIGENT OPTIMIZED BIDDING IN A BATTERY ENERGY STORAGE SYSTEM

(71) Applicant: FLUENCE ENERGY, LLC, Arlington, VA (US)

(72) Inventors: Mohamamdhassan Abdollahi SOFLA, Raleigh, NC (US); Puneeth Devanand KALAVASE, Oakland, CA (US); Isaiah Dallas JEFFERSON, JR., Mitchellville, MD (US)

(73) Assignee: FLUENCE ENERGY, LLC, Arlington, VA (US)

(21) Appl. No.: 18/873,300

(22) PCT Filed: Sep. 26, 2024
(86) PCT No.: PCT/US2024/048595

§ 371 Date: Dec. 9, 2024

Related U.S. Application Data
(60) Provisional application No. 63/541,540, filed on Sep. 29, 2023.

(51) Int. Cl. H02J 3/008; H02J 3/32; H02J 3/38; H02J 7/00; H02J 7/34; H02J 7/44; H02J 7/80

(52) U.S. Cl. CPC H02J 3/008; H02J 3/32; H02J 3/381; H02J 7/34; H02J 7/44; H02J 7/80; H02J 7/865; H02J 2207/20

(57) ABSTRACT

A system includes a plurality of energy storage nodes and at least one processor arranged to perform operations in accordance with programming and acquire state data of components of the system where the state data of at least a plurality of battery modules and at least one inverter of the plurality of energy storage nodes is measured and stored in a memory. The acquired state data is analyzed to determine whether a value of the data exceeds a predicted limit provided in an algorithm of previous bidding information. When the value of the acquired state data exceeds a predicted limit, a cost function model is applied for at least one of the battery modules, the inverter, and an operating efficiency of the system. An optimized gain value of the algorithm for a next energy bidding is adjusted based upon the acquired state data and the cost degradation value.

### CROSS-REFERENCE TO RELATED APPLICATIONS

This application claims priority under 35 U.S.C. § 120 to U.S. Patent Application No. 63/541,540 filed on Sep. 29, 2023, titled “System and Method for Intelligent Optimized Bidding in a Battery Energy Storage System,” the entire disclosure of which is incorporated by reference herein.

### TECHNICAL FIELD

The present subject matter relates to examples of systems and methods for using multifactor analysis beyond revenue-maximization to optimize bidding on energy managed by battery energy storage systems (BESS) and control of the BESS.

### BACKGROUND

Battery energy storage systems, compound energy storage systems, as well as some energy provisioning systems, provide and absorb energy to and from an electrical grid based on the current price of energy in that electrical grid: the energy provisioning system sells or provides energy when the price of a kilowatt is high, or a battery energy storage system buys or absorbs energy when the price of a kilowatt is low. In doing so, energy storage systems help the electrical grid provide energy efficiently when over- or under-subscribed, while also maximizing energy revenue for the owner of the energy provisioning system.

However, the existing bidding optimization algorithms in contemporary energy provisioning systems is revenue-based, meaning that those algorithms do not account for the cost of operation and lifetime of the energy provisioning system. This presents issues as the end of life (EOL) of batteries in a battery energy storage system is significantly influenced by power control strategies—for example, rapidly charging and discharging batteries will degrade them at an accelerated rate over charging and discharging within nominal rates. The EOL of batteries can be improved when the batteries are controlled using optimized methods. Ultimately, the overall profit of an energy provisioning system such as a battery energy storage system is not merely based on energy revenue, but also the EOL of its batteries and the efficiency of the operating point in batteries.

The EOL of inverters in energy provisioning systems are also mainly impacted by the operation condition. Stress factors such as DC link voltage, current, and temperature can impact the lifetime of the inverter. The operating costs can also include the overall efficiency of systems such as batteries, inverters, and logic power in a battery energy storage system, as well as the costs of utilizing auxiliary power—the impacts of all of these factors on the total efficiency of a battery energy storage system can be significant.

### SUMMARY

Hence, there in a need for systems and methods for improving energy bidding strategies on behalf of energy provisioning systems to efficiently maximize the lifespan of components. The lifetime-extending bidding technologies disclosed herein optimize the control of energy provisioning systems such as battery energy storage systems based on total customer profit in the lifetime of the energy provisioning systems. The lifetime-extending bidding technologies use additional optimization functions that account for degradation factors of inverters, batteries. The lifetime-extending bidding technologies consider the operating efficiency of the energy provisioning systems. Each bidding will have additional information from the energy provisioning systems and will optimize the bid to maximize customer profit. The lifetime-extending bidding technologies includes a machine learning method to self-tune after every bid and receiving the system state variables.

Overall, the lifetime-extending bidding technologies increase the total profit of the operator of the energy provisioning system, increase the operating efficiency of the energy provisioning system, and delay battery and inverter degradation and the need for augmentation.

In a first example, a system for intelligent optimized bidding includes an energy storage system 100 including a plurality of energy storage nodes 110A-N and a performance monitoring system element 105. Each of the plurality of storage nodes 110A-N includes a plurality of battery modules 412A-N. The performance monitoring system element 105 includes at least one processor 712, 752 coupled to the energy storage nodes 110A-N and a memory 713, 753 configured to store data and programming. The at least one processor 712, 752 of the performance monitoring system element 105 is configured to perform operations in accordance with execution of the programming 500, obtain previous energy bidding information including at least one of a unit price and a total power amount purchased in a last energy bidding. The processor is further configured to acquire state data of components of the energy storage system. The state data of at least the plurality of battery modules 412A-N and at least one inverter 104 of the plurality of energy storage nodes 110A-N is measured and stored in the memory 712, 753 coupled to the at least one processor. The at least one processor is further configured to analyze the acquired state data to determine whether a value of the acquired data exceeds a predicted limit provided in an algorithm of the previous energy bidding information. When the value of the acquired data does not exceed the predetermined value, a result of the determination is reported. When the value of the acquired state data exceeds the predicted limit, the at least one processor is configured to apply a cost function model for at least one of the plurality of battery modules 412A-N, the at least one inverter 104, and an operating efficiency of the energy storage system. The at least one processor is further configured to adjust an optimized gain value of the algorithm for a next energy bidding based upon the acquired state data and the cost degradation value for the plurality of battery modules, the at least one inverter, and the operating efficiency of the energy storage system.

In a second example, non-transitory computer-readable medium includes an intelligent optimized bidding (IOB) module 500. Execution of the IOB module 500 by one or more processors 712, 752 configures one or more computing devices to obtain previous energy bidding information 520 including at least one of a unit price and a total power amount purchased in a last energy bidding, and acquire state data 525 of components of an energy storage system 100 including a plurality of energy storage nodes 110A-N and at least one inverter 104, each energy storage node 110A-N including a plurality of battery modules 412A-N. The state data of at least the plurality of battery modules 412A-N and at least one inverter 104 of the plurality of energy storage nodes 110A-N is measured and stored in the memory 713, 753 coupled to the one or more processors 712, 752. The one or more computing devices are further configured to analyze 535 the acquired state data to determine whether a value of the acquired data exceeds a predicted limit provided in an algorithm of the previous energy bidding information. When the value of the acquired data does not exceed the predetermined value, a result of the determination is reported. When the value of the acquired state data exceeds the predicted limit, one or more computing devices are configured to apply a cost function model 602, 604, 606 for at least one of the plurality of battery modules 412A-N, the at least one inverter 104, and an operating efficiency of the energy storage system 100, and adjust an optimized gain value of the algorithm for a next energy bidding based upon the acquired state data and the cost degradation value for the plurality of battery modules 412A-N, the at least one inverter 104, and the operating efficiency of the energy storage system 100.

In a third example, a method for intelligent optimized bidding includes obtaining previous energy bidding information 520 including at least one of a unit price and a total power amount purchased in a last energy bidding, and acquiring state data of components 525 of an energy storage system 100 including a plurality of energy storage nodes 110A-N and at least one inverter 104, each energy storage node 110A-N including a plurality of battery modules 412A-N. The state data of at least the plurality of battery modules 412A-N and at least one inverter 104 of the plurality of energy storage nodes is measured and stored in the memory 713, 753 coupled to the energy storage nodes 110A-N. The method further includes analyzing the acquired state data 525 to determine whether a value of the acquired data exceeds a predicted limit provided in an algorithm of the previous energy bidding information. When the value of the acquired data does not exceed the predetermined value, the method includes reporting a result of the determination 530. When the value of the acquired state data exceeds the predicted limit, the method further includes applying a cost function model 535, 540 for at least one of the plurality of battery modules 412A-N, the at least one inverter 104, and an operating efficiency of the energy storage system, and adjusting an optimized gain value of the algorithm for a next energy bidding based upon the acquired state data and the cost degradation value for the plurality of battery modules, the at least one inverter, and the operating efficiency of the energy storage system.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1A is an isometric view of a battery energy storage system that includes multiple energy storage nodes, a central control system element, and an external grid.

FIG. 1B is an isometric view of a single energy storage node, multiple optional energy storage nodes, and an external grid.

FIG. 2 is an electrical diagram of a battery energy storage system similar to that of FIGS. 1A-B depicting information and working power flows.

FIG. 3 is a system diagram of a battery energy storage system similar to that of FIGS. 1A-B depicting step-up converter controllers and the distributed nature of a battery energy storage system.

FIG. 4 is an isometric translucent view of the energy storage node of FIG. 1B that includes a battery bank of multiple battery modules.

FIG. 5 is a flowchart depicting an intelligent optimized bidding (IOB) control process.

FIG. 6 is a diagram depicting a cost model of the degradation of batteries, a cost model of the degradation of inverters, as well as a cost model of operating efficiency.

FIG. 7 is a high-level functional block diagram of the energy storage system of FIGS. 1A and 1B that depicts components of a control system including a performance monitoring system element and the energy storage nodes to control power flow, overall operations and implementation of the intelligent optimized bidding (IOB) protocol.

| | Parts Listing |
|---|---|
| 100 | Battery Energy Storage System (BESS) |
| 102 | Energy Source |
| 104 | Power Conversion System (PCS) |
| 105 | Performance Monitoring System element |
| 106 | Connected Load |
| 108 | Control Subsystem |
| 109A-N | Battery Data |
| 110A-N | Energy Storage Nodes |
| 111 | Energy Storage Element |
| 112 | Required Power Flow |
| 113 | External Grid |
| 114A-C | Distributed PCS |
| 115 | Overall Operations |
| 150 | Battery Array |
| 155A-C | Battery Core |
| 200 | Battery Energy Storage System |
| 211 | Core Controller |
| 212 | Power Plant Controller |
| 251 | High Voltage (HV) Bus |
| 252 | Medium Voltage (MV) Bus |
| 254 | Point of Connection (POC) |
| 255A-N | Data Collection Sensors |
| 256A-N | Meter Readings |
| 257 | HV/MV Transformer |
| 258A-X | Core Transformer |
| 259A-X | Core |
| 260A-X | Circuit Breaker (CB_Core) |
| 261 | HV Circuit Breaker (CB_HV) |
| 262 | Array |
| 410A-F | Battery String |
| 412A-N | Battery Modules |
| 413 | Battery Bank |
| 500 | Intelligent Optimized Bidding (IOB) Process |
| 602 | Cost Model for Battery Degradation |
| 604 | Cost Model for PCS Degradation |
| 606 | Cost Model for Operating Efficiency |
| 705 | Network |
| 710 | Physical Space |
| 711 | Network Communication Interface |
| 712 | Processor |
| 713 | Memory |
| 716A-N | Battery Conditions |
| 751 | Network Communication Interface |
| 752 | Processor |
| 753 | Memory |
| BMS | Battery Management System |
| APS | Apparent Power System Controller |
| Node SDU | Node Storage Dispatch Unit |
| MDU | Market Dispatch Unit |
| RTAC | Real Time Automation Controller |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

The term “coupled” as used herein refers to any logical, physical, electrical, or optical connection, link or the like by which electricity, power, signals or light produced or supplied by one system element are imparted to another coupled element. Unless described otherwise, coupled elements or devices are not necessarily directly connected to one another and may be separated by intermediate components, elements, or communication media that may modify, manipulate, or carry the electricity, power, light or signals.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +5% or as much as +10% from the stated amount. The terms “approximately,” “significantly,” or “substantially” means that the parameter value or the like varies up to +25% from the stated amount.

The orientations of the battery nodes, cores, arrays, racks, elements, modules, submodules, strings, banks, or cells; associated components; circuits; and/or any complete devices, such as battery energy storage systems, combined energy storage systems, or modular energy storage systems, incorporating battery nodes, racks, elements, modules, submodules, strings, banks, or cells such as shown in any of the drawings, are given by way of example only, for illustration and discussion purposes. In operation for a particular battery energy storage application, a battery node, core, array, rack, element, module, submodule, string, bank, or cell may be oriented in any other direction suitable to the particular application of the battery energy storage system, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system or battery nodes, racks, elements, modules, submodules, strings, banks, or cells; or component of an energy storage system or battery node, rack, element, module, submodule, string, bank, or cell examples illustrated in the accompanying drawings and discussed below.

Unless otherwise indicated, any multiplicity of components, such as energy storage nodes 110A-N, battery strings 410A-F, or battery modules 412A-N can include any number of said components, including as few as one, and are not limited by the depicted number of components. Unless otherwise indicated, any coupled electrical components can be linked in series or in parallel. In the case of energy storage nodes 110A-N or battery modules 412A-N, the component may be linked in both series and/or in parallel, depending upon the state of the switch or submodule.

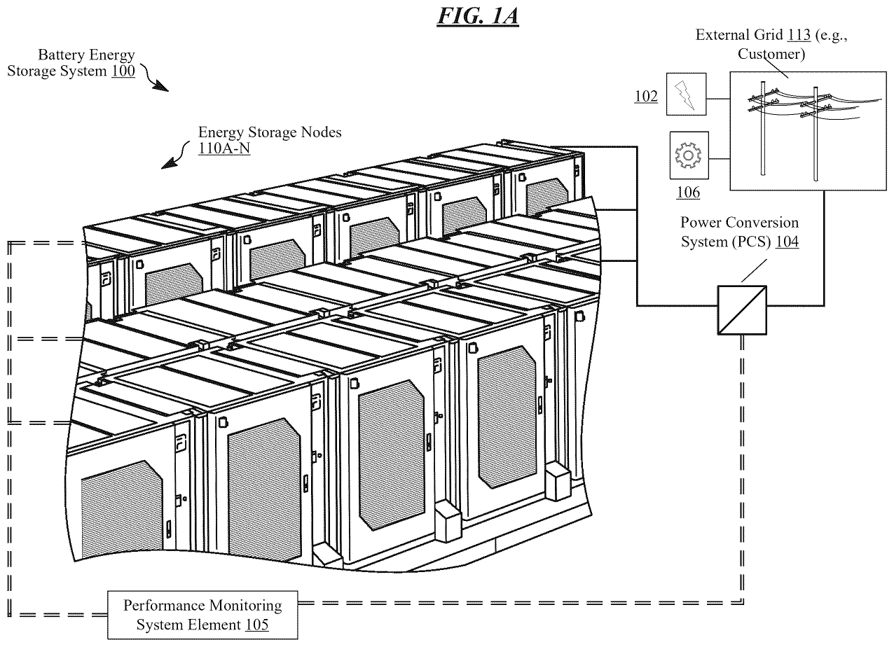

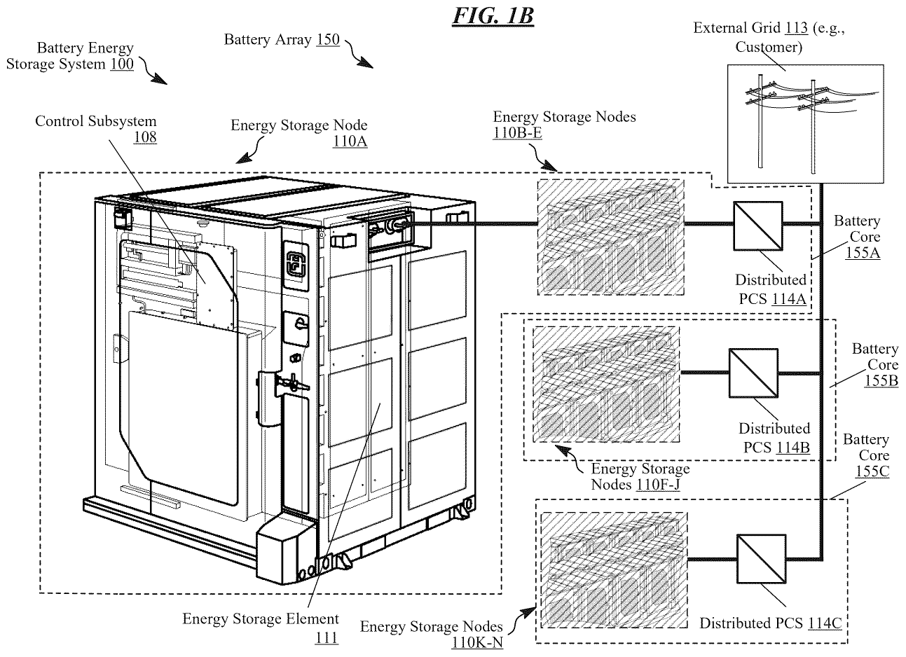

FIG. 1A is an isometric view of a battery energy storage system (BESS) 100 that includes multiple energy storage nodes 110A-N, a control system including a performance monitoring system element 105, and an external grid 113. The battery energy storage system 100 includes multiple energy storage nodes 110A-N optionally connected to a power conversion system (PCS) 104. The energy storage nodes 110A-N include batteries of any existing or future reusable battery technology including, for example, lithium ion, flow batteries, or mechanical storage such as flywheel energy storage, compressed air energy storage, pumped storage hydroelectricity, gravitational potential energy, or a hydraulic accumulator. The energy storage nodes 110A-N, collectively and individually, are capable of providing direct current electricity to an external load, for example, connected load 106, and thereby discharging, as well as are capable of receiving direct current electricity from an external source, for example, energy source 102, and thereby charging.

The energy source 102 can be part of any suitable system for producing electrical energy. In an example, the system can be a renewable energy system in which the energy source 102 can be replenished. Such a renewable energy source 102 can include solar power, wind power, geothermal power, biomass, and hydroelectric power. For example, the renewable energy system can be implemented as an array of photovoltaic modules. The photovoltaic (PC) modules can include crystalline silicon, amorphous silicon, copper indium gallium selenide (CIGS) thin film, cadmium telluride (CdTe) thin film, and concentrating photovoltaics which use lenses and curved mirrors to focus sunlight onto small, but highly efficient, multi-junction solar cells. In another example, the energy system for the energy source 102 can be a non-renewable energy system in which the energy source 102 includes a non-renewable energy source, such as fossil fuel.

To facilitate providing and receiving direct current, the energy storage nodes 110A-N can be connected to the central power conversion system 104. The power conversion system 104 is configured to standardize power inputs and outputs to and from the energy storage nodes 110A-N. The power conversion system 104 can be comprised of: (1) an inverter, converting the DC source of the energy storage nodes 110A-N to an AC waveform, and vice versa; (2) a DC/DC converter, converting the DC source of the energy storage nodes 110A-N to a different DC source characteristic; (3) other known power conversion elements; or (4) a combination thereof.

When the energy storage nodes 110A-N provide direct current, the power conversion system 104 transforms direct current into alternating current for use by the external grid 113 and normalizes the amperage from the battery modules (not pictured) of the energy storage nodes 110A-N to the external grid 113. Additionally, when the energy storage nodes 110A-N require direct current, the power conversion system 104 transforms alternating current into direct current from the external grid 113 and normalizes the amperage from the external grid 113 to the energy storage nodes 110A-N. As shown in FIG. 1B, the energy storage nodes 110A-N are coupled in groups to a distributed power conversion system 114A-C, which may perform some or all of the tasks of a power conversion system 104, and may obviate entirely the use of a central power conversion system 104.

The battery energy storage system 100 including the energy storage nodes 110A-N (and the power conversion system 104 and when the power conversion system 104 is not omitted) is depicted with a single connection to the external grid 113. In scenarios where the external grid 113 is complex and connects to multiple energy sources 102 and connected loads 106, such as a power grid with consumption devices, a single connection to the battery energy storage system 100 can either absorb energy produced by the energy sources of the external grid 113 in excess of the demand of the connected loads of the external grid 113, or provide energy to the connected loads of the external grid 113 in excess of the capacity of the energy sources of the external grid 113. Alternatively, separate lines may run to a segregated energy source as well as to connected loads or the external grid 113. Separate lines may be advantageous in scenarios where the segregated energy source is inconsistent, such as a wind or solar-based energy source. In such scenarios, the power from the energy source is pushed to the energy storage nodes 110A-N, which then either charge or discharge, and provide consistent energy to the connected loads or external grid 113 via another electrical route.

An energy source 102 can be any suitable system for producing electrical energy, such as a turbine or photovoltaic cell. The external grid 113 can include a power grid or a smaller local load such as a backup power system for a facility such as a hospital, manufacturing site, residential home, or other suitable facility.

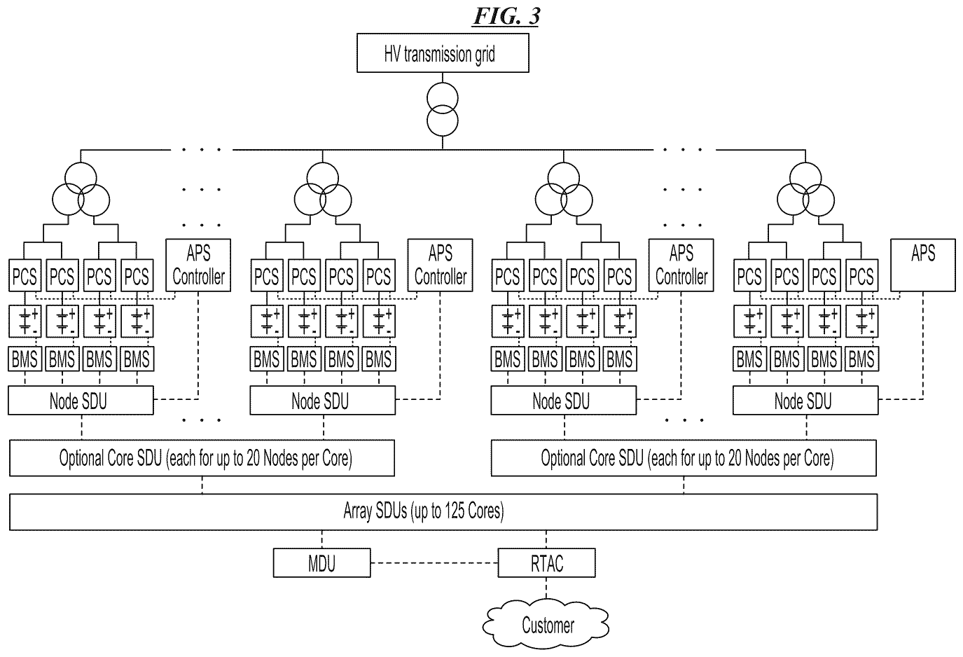

The power conversion system 104 can facilitate normalizing input or output wattage or voltage, in order to provide consistent output and protect the energy storage nodes 110A-N or external grid 113 from damage. The power conversion system 104 may perform this normalization in concert with a control system, including a performance monitoring system element 105. The performance monitoring system element 105 also communicates with and controls the energy storage nodes 110A-N in order to adjust electrical output, as well as electrical capacity or intake of the energy storage nodes 110A-N. The performance monitoring system element 105 has components, such as those depicted in FIG. 3 which operate independently at their respective levels. Therefore, the performance monitoring system element 105 and the distributed control system elements (e.g., BMSs, APS controllers, SDUs, MDUs, and RTAC (see FIG. 3)) are configured to operate in a combination of independent and centralized operation.

Generally, the energy storage nodes 110A-N of the battery energy storage system 100 connected to the external grid 113 operate in concert: either providing power to the external grid 113 and discharging or receiving power from the external grid 113 and charging. This concerted effort is coordinated by performance monitoring system element 105, and other control units such as market dispatch units (MDUs) or real-time automation controllers (RTACs), not depicted FIGS. 1A and 1B. Further methods and systems related to the management and maintenance of the energy storage nodes 110A-N (e.g., battery modules 412A-N) of the battery energy storage system 100 are disclosed in U.S. application Ser. No. 17/810,983, filed on Jul. 6, 2022, now U.S. Pat. No. 11,789,086, issued Sep. 27, 2023, titled “Cell and Rack Performance Monitoring System and Method,” the entirety of which is incorporated by reference herein.

FIG. 1B is an isometric view of an energy storage node 110A, multiple optional energy storage nodes 110B-N, and an external grid 113. The energy storage node 110A includes an energy storage element 111.

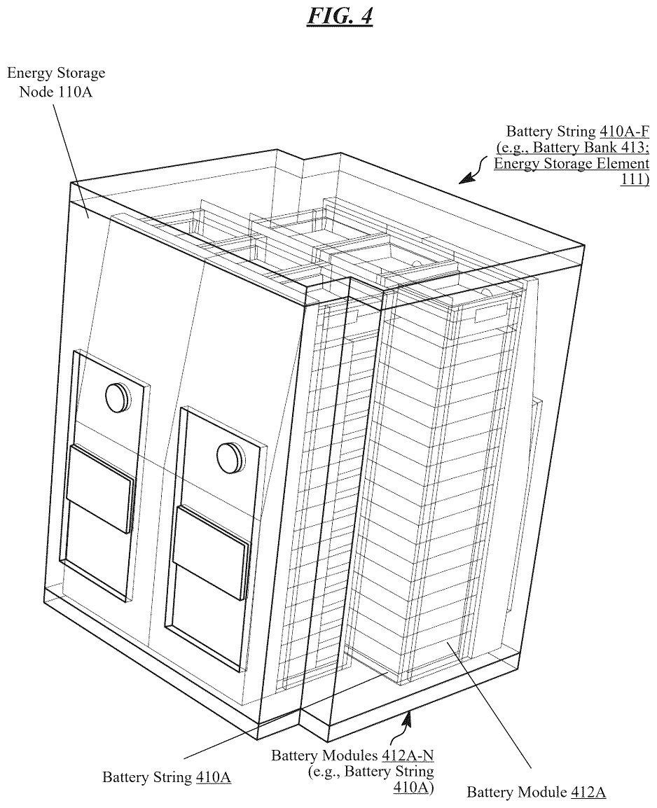

The energy storage element 111 can include: (1) a single battery cell; (2) a cell grouping, including several battery cells in parallel configuration; (3) a battery submodule or module 412A (see FIG. 4), including several battery cells in parallel and serial configuration; (4) a battery string 410A (see FIG. 4), including several battery modules 412A-N in series; (5) a battery bank 413 (see FIG. 4), including several battery strings 410A-F in parallel; (6) other known energy storage elements; or (7) a combination thereof.

The energy storage node 110A can include HVAC heating or cooling elements to regulate the temperature of the energy storage node 110A, in particular the energy storage element 111.

The energy storage nodes are organized into collections of nodes 110A-E, 110F-J, 110K-N, each collection paired with a distributed power conversion system 114A-C. A grouping of nodes 110A-E with a distributed power conversion system 114A constitutes a battery core 155A.

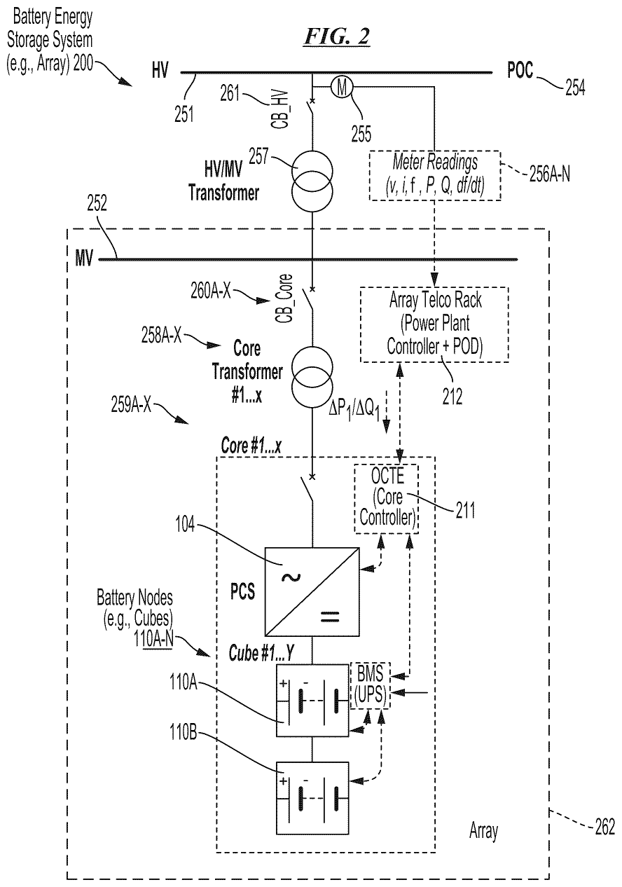

The distributed power conversion system 114A-C can include: (1) an inverter, converting the DC source of the energy storage element 111 to an AC waveform, and vice versa; (2) a DC/DC converter, converting the DC source of the energy storage element 210 to a different DC source characteristic; (3) other known power conversion elements; or (4) a combination thereof. The distributed power conversion systems 114A-C can service an individual energy storage node 110A, or any number of energy storage nodes 110A-N. Multiple energy storage nodes 110A-N are generally arranged in series, although other wiring sequences are contemplated. A distributed power conversion system 114A servicing multiple energy storage nodes 110A-E can be a battery core 155A and can be controlled by a core controller 212 (see FIG. 2). The core controller 212 can coordinate with a node controller present in each associated energy storage node 110A-E.

Physical data collection sensors 255A-N and data logging can be used through the battery energy storage system 100, to collect operational and environmental data, in particular voltage, current, temperature, or power frequency from the components of the battery energy storage system, such as the energy storage node 11A, and the distributed PCSs 114A-C to provide data for analysis and control of the BESS.

FIG. 2 is an electrical diagram of a battery energy storage system 200 similar to the battery energy storage system 100 of FIG. 1 depicting information and working power flows.

The battery energy storage system 200 connects to an electrical grid, including both an energy source 102 and a connected load 106, via a point of connection (POC) 254. The POC 254 is coupled to a high voltage (HV) bus 251, which is an electrical bus rated and intended for high voltage matching the voltage expected by the electrical grid. The HV bus 251 can allow for multiple battery energy storage systems 200 or power storage or generating facilities to be linked in series or in parallel before connecting to an electrical grid via the POC 254.

The battery energy storage system 200 includes an HV circuit breaker 261, designed to selectively isolate the remainder of the battery energy storage system 200 from the HV bus 251. The HV circuit breaker 261 may be hardwired to trip under certain circumstances, or the HV circuit breaker 261 may be controlled by the power plant controller 212 or other controllers.

An HV/medium voltage (MV) transformer 257 is coupled between the HV bus 251 and an MV bus 252. The HV/MV transformer steps the voltage experienced at the HV bus connection end 251 down to the voltage expected at the MV bus 252 connection end, as well as stepping up the voltage from the MV bus 252 connection end to the voltage expected at the HV bus 251 connection end.

The MV bus 252 is within the bounds of the array 262. The array 262 includes a power plant controller 212 to facilitate operation of one or more cores 259A-X. While multiple arrays 262 may be coupled in series or in parallel to the MV bus 252, in this example only a single array 262 with a single power plant controller 212 is depicted.

A core 259A is coupled to the MV bus 252 by a core transformer 258A and a core circuit breaker 260A. Multiple cores 259A-X are connected to a single MV bus 252, each with a respective core transformer 259A-X and respective core circuit breaker 260A-X: in this figure, only a single core 259A is depicted in detail.

The MV circuit breaker 260A is designed to selectively isolate the remainder of the core 259A from the MV bus 252. The MV circuit breaker 260A may be hardwired to trip under certain circumstances, or the MV circuit breaker 260A may be controlled by the power plant controller 212, the core controller 211, or other controllers.

The core transformer 258A is coupled between the MV bus 252 and the core 259A. The core transformer 258A steps the voltage experienced at the MV bus connection end 252 down to the voltage expected at the core 259A connection end, as well as stepping up the voltage from the core 259A connection end to the voltage expected at the MV bus 252 connection end.

The core 259A includes the power conversion system 104, which includes all hardware and controls to convert bi-directionally between direct current (DC) and alternating current (AC) power. The power conversion system 104 provides AC power to and from the MV bus 252, and provides DC power to and from the battery nodes (e.g. cubes) 110A-N.

At least one data collection sensor, for example, a meter 255 may be connected, for example, near the HV bus 251 for the purpose of collecting at least measured values relevant to oscillation determinations: instant voltage, current, as well as power frequency, instant power, and the rate of change of frequency, are all values that can inform the power plant controller 212 and the performance monitoring system element 105 in dampening power oscillations.

The meter readings 256A-N are collected continuously or periodically by the meter, and are provided to the power plant controller 212.

FIG. 3 is a high-level system diagram of a battery energy storage system similar to that of FIGS. 1A-B depicting step-up converter controllers and the distributed nature of a battery energy storage system. Energy storage nodes including a plurality of battery modules are electrically connected to power conversion systems (PCSs), which are then electrically connected together via a bus, then electrically connected via a three-winding transformer to another bus, which then electrically connects to the HV voltage grid via a transformer. The energy storage nodes may be controlled by battery management systems (BMSs), which, along with the PCSs, communicate with apparent power system controllers (APSs). The APSs and the BMSs communicate with node storage dispatch units (SDUs). Node SDUs interface with and monitor the connected BMSs, PCSs and other hardware to higher level controls. The node SDUs communicate with core SDUs, which dispatch real and reactive power to the Nodes based on their operation conditions, as well as provide, for example, telemetry values to the node SDUs, and provide the array SDU and node SDUs with core-level system operation data. The core SDUs communicate with the array SDU, which provides a market dispatch unit (MDU) and real-time automation controller (RTAC) with measurements and system operation data. The array SDU also dispatches real and reactive power to the core SDUs based on core-level stored energy. The MDU executes real and reactive power applications, while the RTAC communicates with customer control systems utilizing adjustable various interfaces.

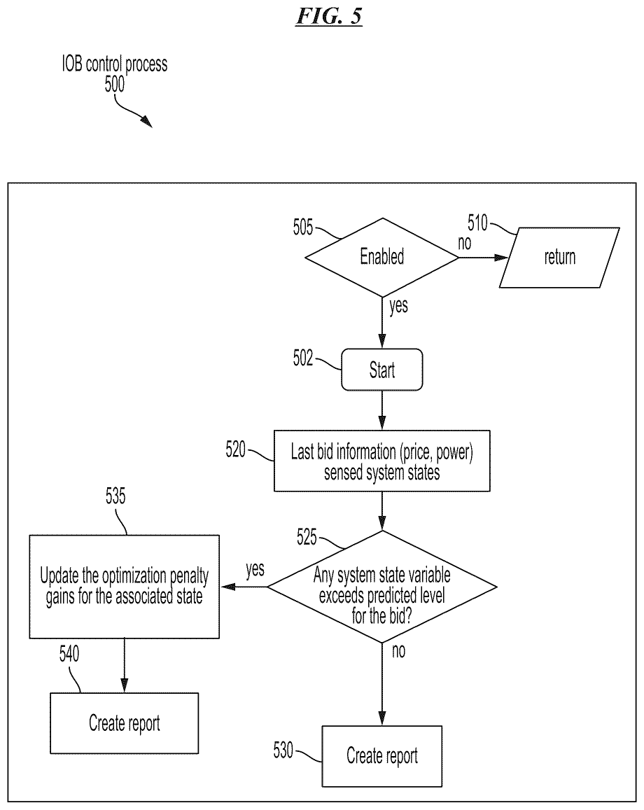

Physical data collection sensors and data logging can be used throughout the battery energy storage system, to collect operational and environmental data from the components of the battery energy storage system, such as the energy storage nodes, PCSs, BMSs, APSs, node SDUs, core SDUs, array SDU, MDU, and RTAC. The data collected can include but is not limited to state of charge, differential voltages, current, or temperature of the energy storage nodes, such as the battery cells, battery modules 412A-N, battery strings 410A-F, and the battery bank 413, the PCSs, BMSs, APSs, node SDUs, core SDUs, array SDU, MDU, or RTAC. The collected data of which is used to derive values for use in operations and implementation of an intelligent optimized bidding control process (see, FIG. 5).

FIG. 4 is an isometric translucent view of the energy storage node 110A of FIG. 1B that includes a battery bank 413 of multiple battery modules 412A-N. The energy storage node 110A stores a plurality of battery strings 410A-F as a battery bank 413 and as an energy storage element 111. The energy storage node 110A is both a physical housing of energy storage element 111, as well as a logical and electrical collection of the battery bank 413 that constitutes energy storage element 111: the energy storage node 110A physically houses the battery bank 413, and the electrical performance of the battery bank 413 comprising the energy storage element 111 may be attributed to the energy storage node 110A itself. For example, if a battery string 410A of the battery bank 413 is able to store one hundred and two kilowatt hours of energy, and the battery bank 413 contains six battery strings 410A-F, then the energy storage node 110A (as well as the energy storage element 111) may be understood to and be described as storing six hundred and twelve kilowatt hours of energy. An energy storage node 110A, energy storage element 111, and battery bank 413 may contain greater or fewer numbers of battery strings 410A-F than depicted in the figure.

A given battery string 410A contains multiple battery modules 412A-N. Much like the relationship between the energy storage node 110A and contained battery bank 413, the battery string 410A is both a physical collection of battery modules 412A-N as well as a logical and electrical collection of battery modules 412A-N. As an example, if a battery module 412A is able to store six kilowatt hours of energy, and the battery string 410A contains seventeen battery modules 412A-N, then the battery string 410A may be understood to and be described as storing one hundred and two kilowatt hours of energy. A battery string 410A may contain greater or fewer numbers of battery modules 412A than depicted in the figures.

As the battery string 410A is a logical and electrical collection of battery modules 412A-N, the collection is not necessarily defined by the physical structure or ordering of the battery cells 412A-N, other than the constituent battery modules 412A-N in this example are wired in series. Therefore, the battery string 410A may be alternatively described as a battery rack, a battery sub-rack, or a battery array: each of these terms (element, rack, sub-rack, array) can be categories of battery string 410A. In some implementations, a finer level of encapsulation exists within the battery module 412A, which may be identified as a battery grouping within the battery module 412. Those battery groupings may also include a finer level of encapsulation, which may be identified as a battery cell within the battery grouping, comprising prismatic, pouch, or cylindrical battery cells.

In this example, the energy storage node 110A represents a single physical fixture, which may be limited in maximum size by the mass or volume a person, forklift, or vehicle is capable of transporting as a singular, atomic unit. The battery bank 413 within the battery module 110A represents a physical organizational structure for organizing and wiring battery cells, groupings, battery modules 412A-N, and battery strings 410A-F within the energy storage node 110A. A battery cell is generally the largest unit of manufacture a battery producer can produce capable of charging and discharging electricity at a chemical level. In some examples battery cells are packaged together as battery modules 412A-N, representing the smallest unit a particular operator would remove or replace in the battery energy storage system 100: in examples where a multiple battery cells are packaged together, the individual battery cells are too small or sensitive to perform on-site particularized maintenance, and instead the entire package of battery cells (e.g., a battery module 412A) is either collectively repaired or replaced.

The energy storage nodes 110A may resemble the features presented in the energy storage system described in International Application No. PCT/US2021/30551, filed on May 4, 2021 (published as WO2021226011 on Nov. 11, 2021), titled “Energy Storage System with Removable, Adjustable, and Lightweight Plenums,” the entirety of which is incorporated by reference herein.

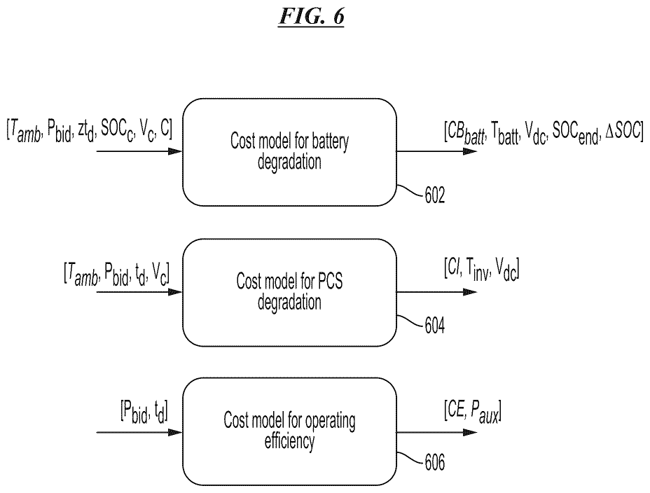

FIG. 5 is a flowchart depicting a profit-based intelligent optimized bidding (IOB) control process 500. The IOB control process 500 is a method to maximize profit of an operation during the lifetime of a BESS 100, rather than a method to maximize revenue of an operation of a BESS 100. The profit of a BESS 100 is impacted greatly by the lifetime of inverters of the PCS 104, energy storage nodes 110A-N, as well as the need for augmentation and the operating efficiency. The JOB control process 500 maximizes profit by adding these cost functions (illustrated in cost modules 602, 604, 606 of FIG. 6) into an existing bidding algorithm for previous bidding information. From a system hierarchical standpoint, this top-level optimization ensures a generated bid of the IOB control process optimizes the profit for the operation.

The BESS 100 lifetime is impacted by various factors. The battery modules of the energy storage nodes 110A-N and inverters of the PCS 104 are the two major components impacting the lifetime of a BESS 100. The average lifetime of a Lithium-ion battery is about 20 years, and the average lifetime of an inverter varies between 10-20 years.

Implementing the JOB control process 500 over an existing BESS 100 will enhance the overall operation profit by extending the lifespan of the battery modules of the energy storage nodes 110A-N and inverters of the PCS 104, and efficiency of the operation of the BESS 100. For example, in a scenario where the Electric Reliability Council of Texas (ERCOT) buy price of electricity is 10 cents/kWh at one point in time, while at another time that the buy price is 40 cents/kWh, it is much more economical to stress the BESS 100 in the higher price rather than in the lower price. Higher returns justify higher costs and lower returns only are reasonable if the costs are lower.

The degradation models (see, 602 and 604 in FIG. 6) for the battery modules 412A-N of the energy storage nodes 110A-N and PCS inverters 104 can be derived from various sources such as research-based battery models or experimental data. The operating efficiency (see, 606 of FIG. 6) curves of the inverters 104 and batteries 110A-N can also be derived from manufacturing data sheets.

A multi-dimensional function of degradation variables and efficiency function are illustrated in FIG. 6 and developed as follows to optimize the bidding. Collective system state variables are defined to describe the degradation cost of the entire BESS in every operational point. Battery degradation is influenced by various key parameters of battery data and battery conditions, including temperature, cycle depth, frequency of cycling, charge/discharge current magnitude, rate of change of state of charge (SOC), and terminal voltage. Implementing optimized control strategies for batteries of the energy storage node 110A-N can lead to a significant reduction in degradation. Furthermore, by optimizing the performance of a BESS 100, degradation can be improved considerably without impacting revenue generation. Table 1 shows the degradation factors for batteries of the energy storage nodes.

TABLE 1
Battery Ideal Operation Profile

| Parameter | Min Range | Max Range |
|---|---|---|
| Temperature | | Tₘₐₓ |
| Current magnitude | | \|Iₘₐₓ\| |
| State of Charge | SOCₘᵢₙ | SOCₘₐₓ |
| Rate of Change of SOC | | ΔSOCₘₐₓ |
| DC Link Voltage | Vₘᵢₙ | Vₘₐₓ |
| Cycling | | C_{dailymax} |

Using a multi-dimensional function approach, the following cost functions are developed for active operation state and idle operation state modes:

$$C {B}_{batt} = [ {k}_{1} {\sum }_{i}^{n} ( {T}_{i} - {T}_{max} ) + {k}_{2} {\sum }_{i}^{n} ( {I}_{i} - {I}_{max} ) + {k}_{3} {\sum }_{i}^{n} ( {SOC}_{i} - {SOC}_{max} ) + {k}_{4} {\sum }_{i}^{n} ( {SOC}_{i} - {SOC}_{min} ) + {k}_{5} {\sum }_{i}^{n} ( Δ {SOC}_{i} - Δ SO {C}_{max} ) + {k}_{6} {\sum }_{i}^{n} ( {V}_{i} - {V}_{max} ) + {k}_{7} {\sum }_{i}^{n} ( {V}_{min} - {V}_{i} ) + {k}_{8} ( t - {t}_{min} ) + {k}_{9} ( C - {C}_{dailymax} ) ]$$

Gains k₁ through k₈ are configurable penalty gains. Summation index n is a number of battery modules in the energy storage node 110A-N, and i is number representing a starting value for a corresponding variable, for example, the summation from 1 to n, or an initial temperature (T) or voltage (V). tₘᵢₙ is the desired time to achieve full SOC. The last term k₈(t−tₘᵢₙ) is used to incorporate the need for a smaller recharge time in order to ensure the highest capacity available in case of a discharge event. C is the number of cyclings (charges and discharges) per day. The collective system state variables of the BESS 100 can be defined by a function of individual subsystem state variables. For example, a summation of variations from the optimum point of each battery module of the energy storage node 110A-N and inverters of the PCS 104 can be used to describe the stress indexes of the entire BESS 100. The cost function increases as the collective system state variables go above the optimum profile. If a state variable is exactly on the optimum point, its impact will be zero; and if a state variable is negative, it is an indication of a more relaxed BESS 100, which allows for room for a higher stressed bidding. Depending on the implementation, negative terms can be zeroed out in order to only consider cost and neglect additional room or factors for stress.

The lifetime of the inverters of PCS 104 is a function of stress factors that impact mainly filter capacitors and switching semiconductors (insulated-gate bipolar transistors (IGBTs), field-effect transistors (FETs), . . . ). Degradation of capacitors and semiconductor switches can be delayed when the number and duration of stress factors are reduced. Table 2 shows these parameters. The formula for CI below is the model of the cost function for the inverter lifetimes.

TABLE 2
Inverter Ideal Operation Profile

| Parameter | Min Range | Max Range |
|---|---|---|
| Temperature | | Tₘₐₓ |
| Current magnitude | | \|Iₘₐₓ\| |
| DC Link Voltage | Vₘᵢₙ | Vₘₐₓ |

$$CI = [ {k}_{1} {\sum }_{i}^{n} ( T - {T}_{max} ) + {k}_{2} {\sum }_{i}^{n} ( I - {I}_{max} ) + {k}_{3} {\sum }_{i}^{n} ( v - {V}_{max} ) + {k}_{4} {\sum }_{i}^{n} ( {V}_{min} - v ) ]$$

Summation index n is the number of inverters of the PCS 104, and i is number representing a starting value for a corresponding variable, for example, the summation from 1 to n. This cost function increases as each of inverter stress factors diverge from the optimum point. If a state variable is zero, that state variable is not cause of stress; and if a state variable is negative, it indicates that the BESS 100 can take on higher stressed bidding. Similar to the above-discussed batteries cost function CB_{batt}, depending on the implementation, negative terms can be zeroed out in order to only consider cost and neglect additional room or factors for stress.

Furthermore, efficiency of the BESS 100 is a major contributor to the total profit of the BESS 100 to the operation. Inverters of the PCS 104 and battery modules of the energy storage nodes 110A-N have an efficiency curve that indicates the most efficient operation mode. Inverters of the PCS 104 usually operate the most efficient at 75% loading. Using these efficiency graphs, an efficiency function can be created for the entire BESS 100. The formula for CE below models this the plant efficiency cost function.

$$CE = [ {k}_{1} ϕ ( {P}_{inv} ) + {k}_{2} ψ ( {P}_{batt} ) + {k}_{3} ψ ( {P}_{aux} ) ]$$

Pᵢₙᵥ is the calculated individual power of each inverter 104, P_{batt} is the calculated individual power of each battery module of the energy storage nodes 110A-N, and Pₐᵤₓ is the auxiliary power for the intended bid. Functions φ, ψ, and Ψ are the cost functions associated with the deviation from the efficient operating points. These cost functions can be derived from the datasheets and specifications for inverters of the PCS 104 and battery modules 412A-N of the energy storage nodes 110A-N. For example, φ can be defined as follows:

$$ϕ = \{ \begin{matrix}0 & if 75 \% {P}_{nom} < {P}_{inv} < {P}_{nom} \\ σ ( {P}_{inv} - {P}_{nom} ) & if 75 \% {P}_{nom} > {P}_{inv}\end{matrix}$$

In the above example for the cost function for the inverter efficiency, the inverter specification has indicated that the inverter is the most efficient at 75% or above of nominal power Pₙₒₘ. At lower percentages above nominal power, a linear cost function is defined that gets higher as the power gets lower with a coefficient σ.

In optimal control, the state variables x(t) are the degradation variables of the batteries and power command is the control input u(t). Using this approach, the optimization is formulated as follows:

$$J = \int {x}^{2} ( t ) K x ( t ) dt$$

$$subject to x = f ( x ( t ) , u ( t ) ) ,$$

where J is the degradation cost function to be minimized. Gain vector K applies penalty for each of the degradation states. The state space model represents the BESS 100 lifetime model. There are various battery module 412A-N lifetime models and inverter of the PCS 104 stress function that have very complex and inefficient implementations. Here, a black box model is considered using machine learning.

The above cost functions (see, FIG. 6, 602, 604, 606) can be directly used as the model of the degradation of battery modules of energy storage nodes 110A-N, degradation of inverters of PCS 104, and the operating efficiency. As noted, FIG. 6 depicts this modeling approach. Each model 602, 604, 606 can be an analytical model or an artificial intelligence-based model. The inputs are T_{amb} for the surrounding air temperature, P_{bid} power to bid, t_{d} time of discharge or charge, SOC, current collective SOC, Ve current collective terminal voltage of batteries 110A-N, and C the number of performed daily cycles. The outputs of the models 602, 604, 606, respectively, are cost of battery degradation, inverter degradation and operating efficiency for every bid. Other outputs are the degradation/stress variables predicted in the models after the power dispatch is complete; battery temperature T_{batt}, inverter temperature Tᵢₙᵥ, DC link voltage V_{dc}, end SOC SOC_{end}, actual rate of change of SOC during dispatch ΔSOC. In another method, an intermediate step could be added to first process the degradation variables in a defined model and using these variables calculate the cost functions above. The advantage of the first method is to have a compressed method with improved processing. The above cost functions can be defined by different functions such as higher order terms.

The above cost functions need to be created using analytical data derived from collected data of the system or by an artificial intelligence method such as neural networks. However, there could be inaccuracies in the modeling. An online machine learning method, for example, updates the optimization functions for specific project and BESS 100 architecture. Therefore, after every bid, at, for example, block 520 of FIG. 5, all the optimization variables will be sensed and the cost functions will be updated. At block 525, if a sensed variable exceeds its predicted limit by the model (e.g., algorithm or artificial intelligence method), then at block 535, the associated penalty gain which are based on the sensed stress factors and corresponding function model will need to be updated. This update will ensure that in the next bid, a more accurate representation of the cost of a bid is considered in the bidding.

To implement the above logic, the profit-based intelligent optimized bidding IOB control process 500 includes the functional blocks illustrated in FIG. 5. First, in block 505, the IOB control process 500 determines whether the IOB control process 500 is enabled. If the IOB control process 500 is disabled by the operator or by upper control layer, block 510 is entered, and the rest of the IOB control process 500 is not implemented.

If the IOB control process 500 is enabled by the operator or the upper control layer, the IOB control process 500 is started. In block 520, the last bid information, including the price per unit and amount of power is obtained from records that may be stored in a memory or externally obtained, and system feedback sensed from the BESS 100, battery modules 412A-N, and inverters of the PCS 104, as well as other components and sub-components, is gathered. In block 525, the IOB control process 500 determines whether any stress or state variable (for example, operating conditions that can impact lifetime such as the variables of Table 1 and Table 2) has hit its respective limit or predicted limit, based on the sensed system feedback. If not, in block 530 a report is generated detailing such result and saved or provided to an operator. However, at block 525, if any system state or stress variable has hit its respective limit or predicted limit, the process flows to block 535 in which the JOB control process 500 updates the related cost function term. As an example, if a battery module of the energy storage node 110A is stressed due to a high discharge rate, the cost function term k₅ term in the C_{batt} equation above is updated to indicate that the BESS 100 should require a proportionally higher electrical price in order to operate this particular battery 110A in this manner. After making this update, the process flows to block 540 and the update to the related cost function is reported to the operator.

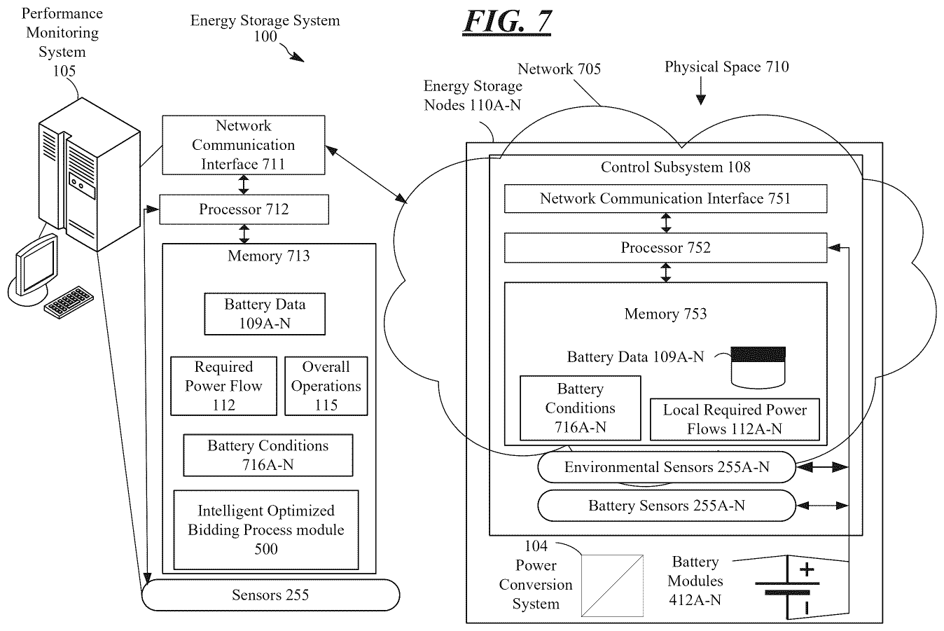

FIG. 7 is a high-level functional block diagram of the energy storage system of FIGS. 1A and 1B that depicts components of a control system including a performance monitoring system element and the energy storage nodes to control power flow, overall operations and implementation of the intelligent optimized bidding (IOB) protocol. As shown, the plurality of energy storage nodes 110A-N includes battery modules 412A-N, a power conversion system 104, and a control subsystem 108 that receive battery data 109A-N from the environmental and battery sensor 255, the battery modules 412A-N, the power conversion system 104, or a combination thereof.

The control system including the performance monitoring system element 105, energy storage nodes 110A-N, external grid 113, and other components of the energy storage system 100 can be in communication over a network 705 or one or more networks 705A-N. The networks 605A-N can be a local area network, wide area network, or a combination thereof. For example, the performance monitoring system element 105 can be coupled via a local area network to the energy storage nodes 110A-N and the external grid 113. Alternative or additionally, the performance monitoring system element 105 can be coupled via a wide area network to the energy storage nodes 110A-N and external grid 113. Or the performance monitoring system element 105 can be coupled via a combination of networks, such as via a local area network to components of the energy storage system 100, including the energy storage nodes 110A-N, and coupled via a wide area network to the external grid 113.

Performance monitoring system element 105 includes a network communication interface 711 configured for wired or wireless communication over the network 705. The performance monitoring system element 105 further includes a memory 713, and a processor 712 coupled to the network communication interface 711 and the memory 713. As shown, the memory 713 of the performance monitoring system element 105 is configured to store battery data 109A-N, a required power flow 112, overall operations 115, and battery conditions 716A-N. The performance monitoring system element 105 can also include sensors 255 coupled to the processor 712 to detect or monitor various system parameters, such as power, temperature, voltage, current, resistance, and/or impedance. For example, the sensors 255 can be coupled to the HV bus 251.

Performance monitoring system element 105 is configured to receive or store a required power flow 112 or overall operations 115. The required power flow 112 can include an active power, a reactive power, or a total system power discharge or charge requirement. The required power flow 112 can be a power command for the external grid 113 based on a customer or independent system operator request received over the network 705 from the external grid 113, in which case the power command is externally determined.

The overall operations 115 can be a power command for the external grid 113 based on parameters in a customer or independent system operator request received over the network 705 from the external grid 113. The performance monitoring system element 105, control subsystem 108, or both can take the parameters of the overall operations 115 and attempt to best implement the overall operations 115. In this case, the power command to achieve the overall operations 115 is internally determined by the performance monitoring system element 105, for example, based on satisfying the customer or independent system operator request for the external grid 113.

Performance monitoring system element 105 can take the required power flow 112 needed for the external grid 103, for example, as requested by a customer or software application or required during the bid into market or otherwise operate assets to optimize the performance of a BESS 100 and improve degradation of components in the system without impacting revenue generation, as discussed above in FIG. 5.

Energy storage nodes 110A-N include a control subsystem 108, battery modules 412A-N, and a power conversion system 104. Control subsystem 110 of the energy storage nodes 110A-N includes a network communication interface 751 configured for wired or wireless communication over the network 705. The control subsystem 108 further includes a memory 753, and a processor 752 coupled to the network communication interface 751 and the memory 753. As shown, the memory 753 of the control subsystem 108 is configured to store battery data 109A-N, battery conditions 716A-N, and local required power flows 112A-N.

The control subsystem 108 further includes environmental sensors 255A-N and battery sensors 255A-N coupled to the processor 752. Environmental sensors 255A-N can measure, for example, humidity and temperature inside of an enclosure of the energy storage nodes 110A-N. Battery sensors 255A-N can include, for example, a voltage sensor, a current sensor, and a temperature sensor to measure readings of battery data 109A-N, such as a voltage, a current, a temperature, or other physical phenomena occurring within the battery modules 412A-N.

In addition to the implementation of the intelligent optimized bidding process 500 (see, FIG. 5) for components within the energy storage system 100, the control subsystem 108 or the performance monitoring system element 105 may be further configured to determine at least one battery condition 716A-O of one or more of the energy storage nodes 110A-N from the battery data 109A-N. Battery conditions 716A-N can be algorithmically determined estimates from battery data 109A-N, or readings from the sensors 255A-N that monitor various system parameters on, for example, the HV bus 251, or a combination thereof.

Each of the energy storage nodes 110A-N can include the power conversion system 104 for controlling the respective one of the local required power flows 112A-N. The battery data 109A-N can include, for example, a voltage, a current, a temperature, or other physical phenomena occurring within the battery module 412A, or a combination thereof.

As discussed above, the battery energy storage system 100, energy storage nodes 110A, power conversion system 104, performance monitoring system element 105 and various controllers may rely on at least one processor, for example, 713, 752. The processor serves to perform various operations, for example, in accordance with instructions or programming executable by the processor. Although the processor may be configured by use of hardwired logic, typical processors are general processing circuits configured by execution of programming. The processor can include elements structured and arranged to perform one or more processing functions, typically various data processing functions. Although discrete logic components could be used, the examples utilize components forming a programmable CPU. The processor for example includes one or more integrated circuit (IC) chips incorporating the electronic elements to perform the functions of the CPU. The processor, for example, may be based on any known or available microprocessor architecture, such as a Reduced Instruction Set Computing (RISC) using an ARM architecture, as commonly used today in mobile devices and other portable electronic devices. Of course, other processor circuitry may be used to form the CPU or processor hardware. Although the described examples of the processor each focus on only one microprocessor, for convenience, a multi-processor architecture can also be used. A digital signal processor (DSP) or field-programmable gate array (FPGA) could be suitable replacements for the processor but may consume more power with added complexity. The processor may also partially or fully comprise (1) a single board computer used for local computation, processing, and control of the battery energy storage system 100, energy storage nodes 110A, power conversion system 104, and various controllers; (2) an application-specific integrated circuit used for local computation, processing, and control of the battery energy storage system 100, energy storage nodes 110A, power conversion system 104, and various controllers; (3) other known distributed control system elements; or (4) a combination thereof.

A memory 713, 753 can be coupled to the processor. 712, 752. Memory devices are for storing data and programming. In the example, memory devices may include a flash memory (non-volatile or persistent storage) and/or a random-access memory (RAM) (volatile storage). The RAM serves as short term storage for instructions and data being handled by the processor e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

A network interface, like network interface 711, 751, can be coupled to the processor. The network interfaces of the battery energy storage system 100, energy storage nodes 110A, power conversion system 104, performance monitoring system element 105, and various controllers are configured to communicate with one another.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A system for intelligent optimized bidding, comprising:
an energy storage system including a plurality of energy storage nodes and at least one inverter, wherein each energy storage node includes a plurality of battery modules; and
at least one processor coupled to the energy storage nodes and a memory configured to store data and programming, wherein the at least one processor is configured to:
perform operations in accordance with execution of the programming;
obtain previous energy bidding information including at least one of a unit price and a total power amount purchased in a last energy bidding;
acquire state data of components of the energy storage system, wherein the state data of at least the plurality of battery modules and the at least one inverter of the plurality of energy storage nodes is measured and stored in the memory coupled to the at least one processor;
analyze the acquired state data to determine whether a value of the acquired state data exceeds a predicted limit provided in an algorithm of the previous energy bidding information, wherein:
when the value of the acquired state data does not exceed the predicted limit, a result of the determination is reported, and
when the value of the acquired state data exceeds predicted limit, apply a cost function model for at least the plurality of battery modules, the at least one inverter, and an operating efficiency of the energy storage system to provide a respective cost degradation value for the plurality of battery modules, the inverter, and the operating efficiency of the energy storage system, and
adjust an optimized gain value for a next energy bidding based upon the acquired state data and the cost degradation value for the plurality of battery modules, the at least one inverter, and the operating efficiency of the energy storage system.

2. The system of claim 1, wherein the plurality of energy storage nodes is collectively and individually arranged to provide direct current electricity to an external load.

3. The system of claim 1, wherein the plurality of energy storage nodes is arranged to receive DC electricity from an external source.

4. The system of claim 1, wherein at least one sensor is arranged within the energy storage system to collect operational and environmental data from the components as the measured state data.

5. The system of claim 1, wherein the measured state data includes at least one of an instant voltage, current, power frequency, instant power, a rate of change of frequency relevant to a dampening power oscillation.

6. The system of claim 1, wherein the optimized gain value is:
$$J = \int {x}^{2} ( t ) K x ( t ) dt$$
$$subject to x = f ( x ( t ) , u ( t ) ) ,$$
where J is the degradation cost function to be minimized for the next energy bidding, and K is a Gain vector penalty applied for each of the degradation states.

7. The system of claim 1, wherein the cost function model for the plurality of battery modules is:
$${CB}_{batt} = [ {k}_{1} {\sum }_{i}^{n} ( {T}_{i} - {T}_{max} ) + {k}_{2} {\sum }_{i}^{n} ( {I}_{i} - {I}_{max} ) + {k}_{3} {\sum }_{i}^{n} ( {SOC}_{i} - {SOC}_{max} ) + {k}_{4} {\sum }_{i}^{n} ( {SOC}_{i} - {SOC}_{min} ) + {k}_{5} {\sum }_{i}^{n} ( {Δ SOC}_{i} - {Δ SOC}_{max} ) + {k}_{6} {\sum }_{i}^{n} ( {V}_{i} - {V}_{max} ) + {k}_{7} {\sum }_{i}^{n} ( {V}_{min} - {V}_{i} ) + {k}_{8} ( t - {t}_{min} ) + {k}_{9} ( C - {C}_{dailymax} ) ]$$
wherein factors of the cost function model for the plurality of battery modules include temperature (T), current magnitude (|I|), state of charge (SOC), rate of change of SOC (ΔSOC), DC link voltage (V), and cycling (C_{dailymax}), and
wherein k₁ through k₈ are configurable penalty gains, and n is a summation index for a number of battery modules in the respective battery node.

8. The system of claim 1, wherein the cost function model for the at least one inverter is:
$$CI = [ {k}_{1} {\sum }_{i}^{n} ( T - {T}_{max} ) + {k}_{2} {\sum }_{i}^{n} ( I - {I}_{max} ) + {k}_{3} {\sum }_{i}^{n} ( V - {V}_{max} ) + {k}_{4} {\sum }_{i}^{n} ( {V}_{min} - V ) ]$$
wherein factors of the cost function model for the at least one inverter include temperature (T), current magnitude (|I|), and DC link voltage (V), and
wherein n is a summation of a number of inverters.

9. The system of claim 1, wherein the cost function model for the operating efficiency for the energy storage system is:
$$CE = [ {k}_{1} ϕ ( {P}_{inv} ) + {k}_{2} ψ ( {P}_{batt} ) + {k}_{3} ψ ( {P}_{aux} ) ]$$
wherein Pᵢₙᵥ is a calculated individual power of each inverter, P_{batt} is a calculated individual power of each battery module, and Pₐᵤₓ is an auxiliary power for an intended bid, and
wherein φ, ψ, and Ψ parameters are values associated with a deviation from predetermined efficient operating points.

10. The system of claim 1, wherein an operation of at least one of the plurality of battery modules is based upon the optimized gain value.

11. A non-transitory computer-readable medium, comprising an intelligent optimized bidding (IOB) module, wherein execution of the IOB module by one or more processors configures one or more computing devices to:
obtain previous energy bidding information including at least one of a unit price and a total power amount purchased in a last energy bidding;
acquire state data of components of an energy storage system including a plurality of energy storage nodes and at least one inverter, wherein each energy storage node includes a plurality of battery modules, wherein the state data of at least the plurality of battery modules and the at least one inverter is measured and stored in a memory coupled to the at least one processor;
analyze the acquired state data to determine whether a value of the acquired state data exceeds a predicted limit provided in an algorithm of the previous energy bidding information, wherein:
when the value of the acquired state data does not exceed the predicted limit, report a result of the determination, and
when the value of the acquired state data exceeds the predicted limit, apply a cost function model for at least the plurality of battery modules, the at least one inverter, and an operating efficiency of the energy storage system to provide a respective cost degradation value for the plurality of battery modules, the inverter, and the operating efficiency of the energy storage system, and
adjust an optimized gain value for a next energy bidding based upon the acquired state data and the cost degradation value for the plurality of battery modules, the at least one inverter, and the operating efficiency of the energy storage system.

12. The non-transitory computer-readable medium of claim 11, wherein the optimized gain value is:
$$J = \int {x}^{2} ( t ) K x ( t ) dt , subject to x = f ( x ( t ) , u ( t ) ) ,$$
where J is the degradation cost function to be minimized for the next energy bidding, and K is a Gain vector penalty applied for each of the degradation states.

13. The non-transitory computer-readable medium of claim 11, wherein the cost function model for the plurality of battery modules is:
$${CB}_{batt} = [ {k}_{1} {\sum }_{i}^{n} ( {T}_{i} - {T}_{max} ) + {k}_{2} {\sum }_{i}^{n} ( {I}_{i} - {I}_{max} ) + {k}_{3} {\sum }_{i}^{n} ( {SOC}_{i} - {SOC}_{max} ) + {k}_{4} {\sum }_{i}^{n} ( {SOC}_{i} - {SOC}_{min} ) + {k}_{5} {\sum }_{i}^{n} ( {Δ SOC}_{i} - {Δ SOC}_{max} ) + {k}_{6} {\sum }_{i}^{n} ( {V}_{i} - {V}_{max} ) + {k}_{7} {\sum }_{i}^{n} ( {V}_{min} - {V}_{i} ) + {k}_{8} ( t - {t}_{min} ) + {k}_{9} ( C - {C}_{dailymax} ) ]$$
wherein factors of the cost function model for the plurality of battery modules include temperature (T), current magnitude (|I|), state of charge (SOC), rate of change of SOC (ΔSOC), DC link voltage (V), and cycling (C_{dailymax}), and
wherein k₁ through k₈ are configurable penalty gains, and n is a summation index for a number of battery modules in the respective battery node.

14. The non-transitory computer-readable medium of claim 11, wherein the cost function model for the at least one inverter is:
$$CI = [ {k}_{1} {\sum }_{i}^{n} ( T - {T}_{max} ) + {k}_{2} {\sum }_{i}^{n} ( I - {I}_{max} ) + {k}_{3} {\sum }_{i}^{n} ( V - {V}_{max} ) + {k}_{4} {\sum }_{i}^{n} ( {V}_{min} - V ) ] ,$$
wherein factors of the cost function model for the at least one inverter include temperature (T), current magnitude (|I|), and DC link voltage (V), and
wherein n is a summation of a number of inverters.

15. The non-transitory computer-readable medium of claim 11, wherein the cost function model for the operating efficiency is of the energy storage system is:
$$CE = [ {k}_{1} ϕ ( {P}_{inv} ) + {k}_{2} ψ ( {P}_{batt} ) + {k}_{3} ψ ( {P}_{aux} ) ] ,$$
wherein Pᵢₙᵥ is a calculated individual power of each inverter, P_{batt} is a calculated individual power of each battery module, and Pₐᵤₓ is an auxiliary power for an intended bid, and
wherein φ, ψ, and Ψ parameters are values associated with a deviation from predetermined efficient operating points.

16. A method for intelligent optimized bidding, comprising:
obtaining previous energy bidding information including at least one of a unit price and a total power amount purchased in a last energy bidding;
acquiring state data of components of an energy storage system, the energy storage system including a plurality of energy storage nodes and at least one inverter, wherein each energy storage node includes a plurality of battery modules, wherein the state data of at least the plurality of battery modules and the at least one inverter of the plurality of energy storage nodes is measured and stored in a memory coupled to the energy storage nodes;
analyzing the acquired state data to determine whether a value of the acquired state data exceeds a predicted limit in an algorithm of the previous energy bidding information, wherein:
when the value of the acquired state data does not exceed the predicted limit, reporting a result of the determination, and
when the value of the acquired state data exceeds the predicted, applying a cost function model for at least the plurality of battery modules, the at least one inverter, and an operating efficiency of the energy storage system to provide a respective cost degradation value for the battery modules, the inverter, and the operating efficiency of the battery storage system, and
adjusting an optimized gain value for a next energy bidding based upon the acquired state data and the cost degradation value for the plurality of battery modules, the at least one inverter, and the operating efficiency of the energy storage system.

17. The method of claim 16, wherein the optimized gain value is:
$$J = \int {x}^{2} ( t ) K x ( t ) dt , subject to x = f ( x ( t ) , u ( t ) ) ,$$
where J is the degradation cost function to be minimized for the next energy bidding, and K is a Gain vector penalty applied for each of the degradation states.

18. The method of claim 16, wherein the cost function model for the plurality of battery modules is:
$${CB}_{batt} = [ {k}_{1} {\sum }_{i}^{n} ( {T}_{i} - {T}_{max} ) + {k}_{2} {\sum }_{i}^{n} ( {I}_{i} - {I}_{max} ) + {k}_{3} {\sum }_{i}^{n} ( {SOC}_{i} - {SOC}_{max} ) + {k}_{4} {\sum }_{i}^{n} ( {SOC}_{i} - {SOC}_{min} ) + {k}_{5} {\sum }_{i}^{n} ( {Δ SOC}_{i} - {Δ SOC}_{max} ) + {k}_{6} {\sum }_{i}^{n} ( {V}_{i} - {V}_{max} ) + {k}_{7} {\sum }_{i}^{n} ( {V}_{min} - {V}_{i} ) + {k}_{8} ( t - {t}_{min} ) + {k}_{9} ( C - {C}_{dailymax} ) ]$$
wherein factors of the cost function model for the plurality of battery modules include temperature (T), current magnitude (|I|), state of charge (SOC), rate of change of SOC (ΔSOC), DC link voltage (V), and cycling (C_{dailymax}), and
wherein k₁ through kg are configurable penalty gains, and n is a summation index for a number of battery modules in the respective battery node.

19. The method of claim 16, wherein the cost function model for the at least one inverter is:
$$CI = [ {k}_{1} {\sum }_{i}^{n} ( T - {T}_{max} ) + {k}_{2} {\sum }_{i}^{n} ( I - {I}_{max} ) + {k}_{3} {\sum }_{i}^{n} ( V - {V}_{max} ) + {k}_{4} {\sum }_{i}^{n} ( {V}_{min} - V ) ] ,$$
wherein factors of the cost function model for the at least one inverter include temperature (T), current magnitude (|I|), and DC link voltage (V), and
wherein n is a summation of a number of inverters.

20. The method of claim 16, wherein the cost function model for the operating efficiency for the energy storage system is:
$$CE = [ {k}_{1} ϕ ( {P}_{inv} ) + {k}_{2} ψ ( {P}_{batt} ) + {k}_{3} ψ ( {P}_{aux} ) ]$$
wherein Pᵢₙᵥ is a calculated individual power of each inverter, P_{batt} is a calculated individual power of each battery module, and Pₐᵤₓ is an auxiliary power for an intended bid, and
wherein φ, ψ, and Ψ parameters are values associated with a deviation from predetermined efficient operating points.
